(19) United States
(12) Patent Application Publication
(10) Pub. No.: US 2006/0077588 A1
(43) Pub. Date: Apr. 13, 2006

(54) Generalized sinusoidal trajectory for seek servomechanism of hard drives

(76) Inventor: Teng-yuan Shih, San Jose, CA (US)

Correspondence Address: Teng-yuan Shih, 1197 Valley Quail Circle, San Jose, CA, 95120, US

(21) Appl. No.: 10/963,264

(22) Filed: Oct. 12, 2004

(51) Int. Cl. G11B 5/596

(52) U.S. Cl. 360/78.06; 360/78.09

(57) ABSTRACT

A hard disk drive moves a transducer across a disk surface so that the transducer has an essentially generalized sinusoidal acceleration trajectory. A digital signal processor known as a controller is used to control the movement of a transducer. The function of a controller is to move the transducer from its present track to a target track in accordance with a seek routine and a servo control routine. During the seek routine the controller moves the transducer in accordance with a generalized sinusoidal current trajectory, which is devised to be a current profile for the seek control to move a transducer from one position to another position robustly and as fast as possible. To form the generalized sinusoidal trajectory, a constant acceleration phase is inserted in the middle of the acceleration phase and also a constant deceleration phase is inserted in the middle of the deceleration phase. For seeks without coast mode, the current trajectory can be divided into five phases based on seeking status. Excluding the phases for constant acceleration and constant deceleration, the current profile becomes a full cycle of sinusoidal wave. Therefore, the generalized sinusoidal waveform is a generalization of the standard sine wave, which has the capability to stay at its design peak for certain duration of time. As a seek trajectory for current, the generalized sinusoidal waveform has three distinguishable characteristics. First, the seek trajectory is capable of a fast seek time design. Second, this seek trajectory is more manageable and smooth than the classical bang-bang control. Third, this seek trajectory provides smooth transition from phase to phase. The current profile is flexible, general and powerful to achieve descent seek performance. When the duration of constant acceleration and constant deceleration is equal to one half of the total seek time, the trajectory reduces to bang-bang curve. When there are no constant acceleration phase and constant deceleration phase, the trajectory reduces to the simple one-frequency sinusoidal wave. Compared to the classical bang-bang control, the generalized sinusoidal waveform has a narrower frequency spectrum, which is less likely to excite mechanical resonance and, therefore, generates lower acoustic noise. The generalized sinusoidal waveform is a new class of trajectories, which has a transducer movement time falling in a range between the sine wave and bang-bang curve depending on its design parameters.

### BACKGROUND OF THE INVENTION

1. Field of the Invention

The present invention relates generally to the design of a method and apparatus for seek control algorithm of servo system design associated with a hard disk drive. Specifically, the invention devises a generalized sinusoidal waveform as current profile for a seek controller to move data heads of a hard disk drive from one position to another position fast and robustly. The period of the generalized sinusoidal waveform is seek-length dependent. The generalized sinusoidal waveform is devised for better servo performance of hard drive systems, including fewer chances to excite mechanical resonance, lower acoustic noise and faster access time. During the process of seeks, the controller forces the movement of a transducer (or recording head) of a disk drive to follow a set of design seek trajectories, including acceleration, velocity and position that are derived from the generalized sinusoidal current profile.

2. Background

Hard disk drives include a plurality of magnetic transducers that can write and read information by magnetizing and sensing the magnetic field of a spinning disk(s), respectively. The information is typically formatted into a plurality of sectors that are located within an annular track. There are a number of tracks located across each surface of the disk. A number of vertically aligned tracks are usually referred to as a cylinder.

Each transducer is integrated into a slider that is incorporated into a head gimbal assembly (HGA), which is referred to as a head or recording head in the following. Each HGA is attached to an actuator arm. The actuator arm is actuated by a voice coil motor (VCM), which is attached to the actuator assembly, and is composed of a coil and a magnetic circuit device. The hard disk drive typically includes a driver circuit and a controller that provide current to excite the VCM in accordance with a servo algorithm. The excited VCM rotates the actuator arm and moves the heads (or, synonymously, transducers) across the surfaces of the disk(s).

When writing or reading information the hard disk drive performs a seek routine to move a head (transducer) from one track to a target track on a disk surface. The controller performs a servo routine to assure the transducer moves to the target position fast and accurately. It is always desirable to minimize the amount of time required to write to and to read from the disk(s). Therefore, the seek routine performed by the drive should move the heads to new positions in shortest possible time. Additionally, the settling time of the HGA should be minimized so that the heads can quickly start the read or write operation when they arrive the commend targets.

Prior art of seek control algorithms include two major seek trajectories: bang-bang control trajectory and standard sinusoidal trajectory. Many disk drive designs utilize a bang-bang control algorithm for the servo routine to move the recording heads (transducers) because the bang-bang trajectory is theoretically the time optimal method. The waveform of the bang-bang current profile is a positive square wave followed by another square wave in opposite direction. Square waveforms contain high frequency harmonics, which are likely to stimulate mechanical resonance of the mechanical system of a hard disk drive. Besides, the current rise time and current switching time for the bang-bang profile are infinitely fast, which is physically not possible. For practical implementation, various modifications are usually necessary to make the bang-bang trajectory work for a hard disk drive. With all these modifications, the bang-bang algorithm is no longer time-optimal for seeks. The mechanical vibrations excited by a bang-bang current profile due to its wide range of frequency contents are often unacceptable for the servo system because of the consideration of stability margin. Additionally, these vibrations are a major source generating acoustic noises during seeks.

A sinusoidal wave of prior art as current profile for seeks has been used as an alternative in the hard disk drive industry. A standard sinusoidal seek trajectory is simply a sine function with seek-length dependent period. There are, at least, two reasons for the change. First, a sinusoidal wave has only one frequency component, which is less likely to excite the mechanical system of a drive. Second, the sinusoidal current profile is very smooth because of the gentle current rise and current switch, and, additionally, the current gradually reduces to zero at the target position for smooth landing. The major shortcoming of a sinusoidal current profile is caused by its rigid waveform. The current rise time of the sinusoidal seek is set by the waveform, and once the current reaches its design peak, it starts to fall off. Briefly, the sinusoidal wave lacks the capability to stay at the design current peak for a finite duration of time; therefore, the only method to improve the movement time of seeks is to increase the amplitude of the current profile, which is usually not possible.

To overcome the inherent rigidity problem of the sinusoidal waveform, there is an approach of prior art, which generates an acceleration trajectory with a constant acceleration phase by employing a Fourier series representation with a finite number of terms. For implementation consideration, the number of terms is limited to very few, such as two or three. The additional terms of the series representation are odd harmonics of the fundamental frequency to emulate the current profile in seeks. Special efforts are made to eliminate the well-known Gibbs phenomenon of classical Fourier analysis of the trajectory. Thus, the approach for seek is named a generalized Fourier seek method because it is not an ordinary Fourier series. The method is capable of generating an acceleration trajectory with constant maximum acceleration for certain duration of time. An optimization method exists in prior art to determine Fourier coefficients by minimizing the total mean-square error. Such a generalized Fourier seek method coupled with the optimization method for the determination of its coefficients involves quite some mathematical manipulations. A major deficiency of the method is its relative inflexibility to adjust the duration of constant phase in the acceleration trajectory.

As an alternative approach to the generalized Fourier seek method, there is another method that uses the extended sinusoidal trajectory for seek servomechanism, which works directly on the geometry of the standard sinusoidal waveform to insert a constant phase of acceleration for faster access time. The extended sinusoidal waveform is constructed by saturating the standard sinusoidal wave at a specified level smaller than unity. The resulting waveform is then normalized to have unit amplitude, which yields the maximum design current after an appropriate scaling. Therefore, the method is very general and flexible for the adjustment of the duration of constant acceleration phase in the acceleration trajectory. Additionally, the seek trajectories generated using the direct method of waveform modification is simpler to use for implementation. The extended sinusoidal waveform is continuous everywhere on its trajectory; however, the slope of this trajectory is not everywhere continuous.

3. Objects and Advantages

As an alternative to the previously mentioned extended sinusoidal trajectory, the generalized sinusoidal trajectory is different in waveform that is essentially a sinusoidal wave with the extension that it allows the peak value (positive for acceleration and negative for deceleration) to stay for a fixed duration of time. The waveform of a generalized sinusoidal profile is both continuous and analytic everywhere on its trajectory. The generalized sinusoidal waveform is constructed by modifying directly on the simple sine function with the insertion of a constant acceleration phase at the maximal and minimal points of the sine wave. FIG. 1 shows the method to generate a generalized sinusoidal waveform without coast mode. When coast mode is present, a typical generalized sinusoidal waveform is given in FIG. 2. For a standard sinusoidal waveform, the positive portion corresponds to the acceleration phase and the negative portion associates with the deceleration phase. However, either the acceleration phase or the deceleration phase of the sinusoidal current profile can be further divided into two sub-phases depending on the slope of current profile in the phase. The acceleration phase can be divided into the initial acceleration phase when the current slope is positive and the final acceleration phase when the current slope is negative. The boundary point between the initial and final acceleration phases is the peak of acceleration. Similarly, we can divide the deceleration phase into the initial deceleration phase and the final deceleration phase depending on the sign of the current slope. The boundary point between the initial and final deceleration phases is the trough of the deceleration phase. The generalized sinusoidal waveform is constructed by inserting a constant acceleration phase in between the initial acceleration phase and the final acceleration and also inserting a constant deceleration phase in between the initial deceleration phase and the final deceleration phase. The total duration of the resulting generalized sinusoidal waveform is then normalized to have unity period. The waveform generated from such a construction method is equivalent to extend the peak of acceleration from a point to a finite duration and to extend the peak deceleration from a point to an equal-length finite duration. Thus, the transducer is capable of achieving much faster seek time using the generalized sinusoidal current profile to replace a standard sinusoidal current profile. The only restraint of the trajectory is that the constant duration for acceleration and deceleration shall not exceed one half of the total duration of the waveform.

In the limiting case when the constant acceleration or deceleration duration gradually increases to be equal to one half of the total duration of the current waveform, the generalized sinusoidal waveform reduces to the conventional bang-bang waveform. When the constant acceleration or deceleration duration shrinks to diminish completely, the generalized sinusoidal waveform reduces to the standard sinusoidal waveform.

The duration of the constant acceleration in a generalized sinusoidal waveform is the same as the duration of the constant deceleration provided that the magnitude of the constant deceleration is equal to the magnitude of the constant acceleration. The duration of either the constant acceleration (or the constant deceleration) of the generalized sinusoidal wave can be easily adjusted and tuned for performance.

The generalized sinusoidal waveform is very versatile because both the bang-bang control waveform and the sinusoidal waveform are its two extreme limiting waves. The generalized sinusoidal current profile has the performance advantages of both bang-bang design and the sinusoidal seek design. A seek control using the generalized sinusoidal current profile is both fast and robust. A comparison of the sine wave, the bang-bang curve and a generalized sinusoidal wave in the time domain is given in FIG. 3. The comparison of these three waveforms in the frequency domain is shown in FIG. 4. It is noted that the bang-bang curve contains many higher frequency components other than the main frequency of the waveform. The sinusoidal wave theoretically has only a single frequency component. Instead of a line, the sinusoidal spectrum concentrates in a narrow frequency range because it is generated from a sampled sine wave. The spectrum of the generalized sinusoidal waveform is generally similar to that of the sine wave, which is clean of noise for most frequency range for a seek length. The beauty of the generalized sinusoidal waveform lies in the fact that it is capable of achieving a fast seek time, and, at the same time, is less likely to excite mechanical resonance as the bang-bang control.

### SUMMARY

The generalized sinusoidal current profile is devised to improve the seek performance of the conventional current profiles for servomechanism in hard disk drive application. A classical bang-bang control curve is physically not practical, which requires significant modifications for implementation. Compared with the sinusoidal seek algorithm, the new current profile can significantly improve the seek time while maintaining descent robustness in control.

The generalized sinusoidal waveform is constructed by inserting a constant acceleration phase in between the initial acceleration phase and the final acceleration phase and, for symmetry, also inserting a constant deceleration phase in between the initial deceleration phase and the final deceleration phase. The waveform thus generated is equivalent to the extension of the peak of acceleration from a point to a finite duration and, at the same time, the extension of the peak deceleration from a point to an equal-length finite duration. The seek time of a transducer using the generalized sinusoidal current profile can be much faster than the use of a sinusoidal current profile. The duration of either constant acceleration peak or constant deceleration peak is adjustable. The constant duration for acceleration and deceleration shall not exceed one half of the total duration of the waveform.

The generalized sinusoidal waveform includes the bang-bang control waveform and the sinusoidal waveform as its two limiting cases when the duration of constant current profile is always at its peak and, for the other extreme, the constant duration does not exist, respectively. Compared to the classical bang-bang control, the generalized sinusoidal waveform has a narrower frequency spectrum, which is less likely to excite mechanical resonance and, therefore, generates lower acoustic noise.

The generalized sine wave is general, flexible and powerful compared to either bang-bang control or sinusoidal seek method. The new current trajectory can be very valuable under certain circumstances. First, when the design of servo system is pursuing a faster seek time, the new trajectory may be used instead of increasing the magnitude of the peak for the sinusoidal trajectory, which, usually, is not a practical choice. Second, under the restriction of certain VCM driver, one may not have a choice to raise maximum current for VCM to meet the criterion of design seek time. Commonly, a hard drive is designed for extreme operating conditions such as at a high temperature of 55° C. environment with 10% supply voltage reduction or at a low temperature of 5° C. environment with 10% supply voltage reduction. The generalized sine wave has a very desirable characteristic that allows the design engineer to reduce the maximum current and, at the same time, to increase the duration of constant acceleration while retaining the same access time of design specification.

The recommended strategy of trajectory usage in seeks is a combination of two waveforms. A reduced generalized sinusoidal wave with no constant acceleration phase (namely, a simple sine wave) shall be used for short to medium range seeks, and, for relatively longer seeks, a generalized sinusoidal waveform with certain constant acceleration duration is used as current profile for best performance.

### DRAWINGS

FIG. 1. Construction of the Generalized Sine Wave for Current Trajectory

(a) Construction of Waveform with Restraints of construction:

$$1. 2 A + B = \frac{1}{2}$$

$$2. A \leq \frac{1}{4}$$

(b) Resulting Generalized Sine Waveform: Trajectory a-b-c-d-e-f

FIG. 2. Construction of Generalized Sine Wave with Coast Mode

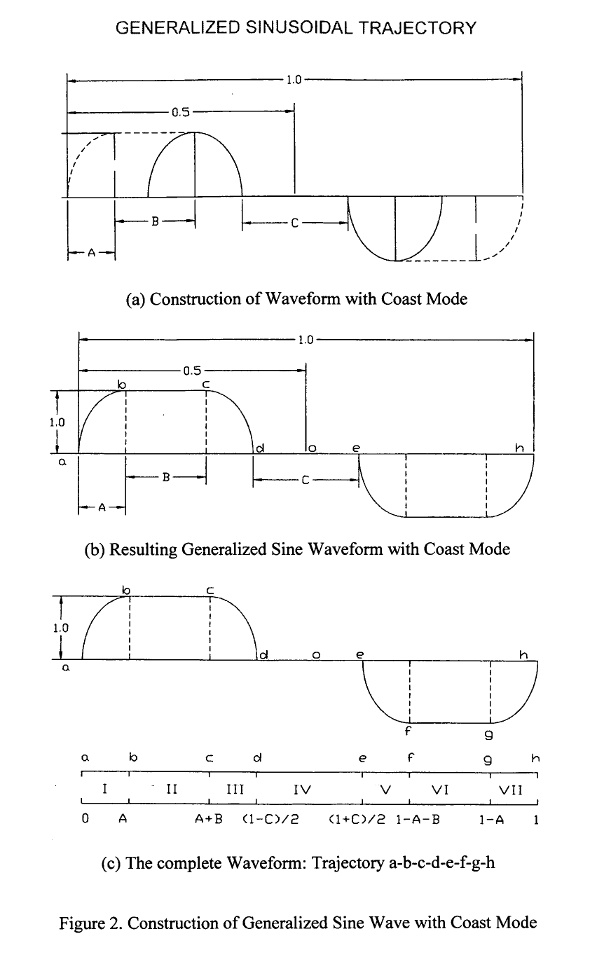

(a) Construction of Waveform with Coast Mode

(b) Resulting Generalized Sine Waveform with Coast Mode

(c) The complete Waveform: Trajectory a-b-c-d-e-f-g-h

FIG. 3. Comparisons of Waveforms in the Time Domain

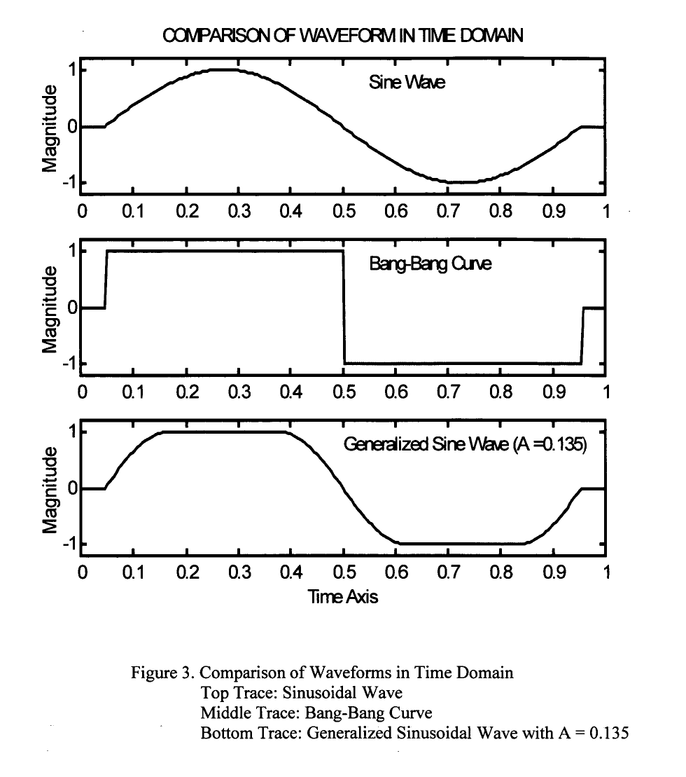

Top Trace: Sinusoidal waveform

Middle Trace: Bang-bang curve

Bottom trace: A generalized sinusoidal waveform with A=0.135

FIG. 4. Comparisons of Waveforms in the Frequency Domain

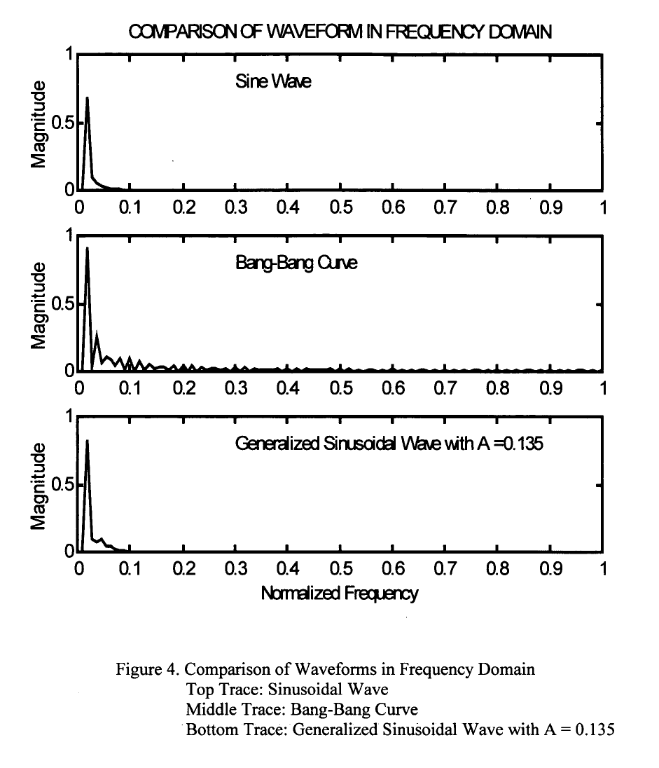

Top Trace: Sinusoidal waveform

Middle Trace: Bang-bang curve

Bottom trace: A generalized sinusoidal waveform with A=0.135

FIG. 5. Comparison of Parametric Seek Trajectories without Coast Mode:

Generalized Sinusoidal Wave (A=0.135) versus Standard Sinusoidal Model

FIG. 6. Seek Trajectories on the Phase Plane without Coast Mode:

Generalized Sinusoidal Wave (A=0.135) versus Standard Sinusoidal Model

FIG. 7. Comparison of Parametric Seek Trajectories with Coast Mode:

Generalized Sinusoidal Wave (A=0.15, C=0.2) versus Standard Sinusoidal Model

FIG. 8. Comparison of Seek Trajectory on Phase Plane with Coast Mode:

Generalized Sinusoidal Wave (A=0.15, C=0.2) versus Standard Sinusoidal Model

FIG. 9. Seek Time Comparison of Generalized Sine Model (A=0.135) versus Sinusoidal Design (Top) and Bang-Bang Control (Bottom)

Increasing the parameter A, the generalized sine model tends to sine wave. By decreasing A, the generalized sine curve tends to bang-bang control. By varying the parameter A

$$( or B = \frac{1}{2} - 2 A ) ,$$

the seek time curve for the generalized sinusoidal model shifts in the range between the sinusoidal seek curve and the bang-bang control curve.

FIG. 10. Seek Controller Using Parametric Seek Trajectories

FIG. 11. Seek Controller Using Seek Trajectory on Phase Plane Seek Controller Using Seek Trajectory on Phase Plane

### DETAILED DESCRIPTION

1. Generation of Current Profile

This trajectory using the generalized sine function for a seek without coast mode can be divided into five phases:
(1) Initial acceleration phase (Initial seek phase)
(2) Constant acceleration phase
(3) Transition phase
(4) Constant deceleration phase
(5) Approaching phase (Near the end-of-seek phase)

The transition phase covers the duration of seek from acceleration to deceleration.

The current profile a(x) in phase I has the property of a(x)>0 with its slope

$$\frac{ⅆ a ( x )}{ⅆ x} > 0 ,$$

and the a(x) reaches its maximum when the slope of current decreases to 0. In phase II, the current is a positive constant, and the slope of current is zero. Depending on the sign of the acceleration slope, Phase III can be further separated into two sub-phases: phase III-A and phase III-B. In phase III-A, we have a(x)>0 and its slope

$$\frac{ⅆ a ( x )}{ⅆ x} < 0.$$

In phase III-B, we have a(x)<0 and its slope

$$\frac{ⅆ a ( x )}{ⅆ x} < 0$$

too. The current a(x) reaches minimum when its slope increases to zero. In phase IV, the current is a negative constant, and the slope of current is zero. In phase V, we have a(x)<0 and its slope

$$\frac{ⅆ a ( x )}{ⅆ x} > 0.$$

Note that the initial acceleration phase (Phase I), transition phase (Phase III) and the approaching phase (Phase V) together forms a complete cycle of a standard sinusoidal wave.

Although the trajectories of Phase III and Phase V are portions of a sine wave, each of them has a separate phase delay.

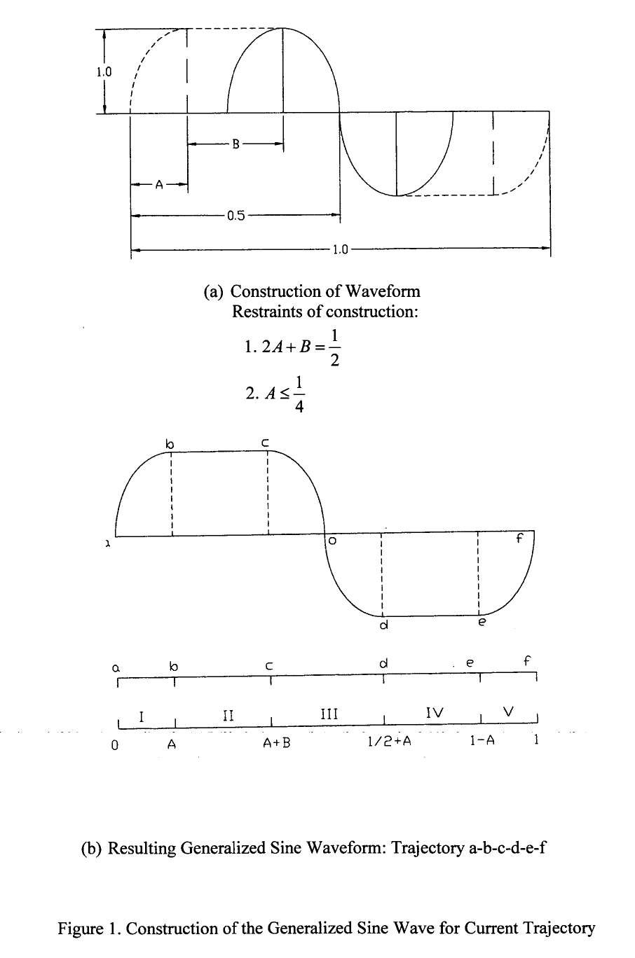

It is instructive to note that both the generalized sine wave and its slope are continuous at every point of the trajectory, including at the boundary points between neighboring phases. As shown in FIG. 1(b), these boundary points between neighboring phases are the points of b, c, d and e.

When a coast mode is present in seeks, the above current trajectory is modified to include two additional phases. Depending on the slope of the current profile, the acceleration phase of the current profile is further divided into the initial acceleration phase and the final acceleration phase. Similarly, the deceleration phase is decomposed into two separate phases depending on the slope of the current profile.

These seven phases of the current profile for seeks with a coast mode are
(1) Phase I: Initial acceleration phase (Acceleration with positive increase rate)
(2) Phase II: Constant acceleration phase
(3) Phase III: Final acceleration phase (Acceleration with negative increase rate)
(4) Phase IV: Coast mode phase
(5) Phase V: Initial deceleration phase (Deceleration with negative increase rate)
(6) Phase VI: Constant deceleration phase
(7) Phase VII: Final deceleration phase (Deceleration with positive increase rate)

The final deceleration phase is synonymous with the approaching phase or near the end-of-seek phase. Note that the combination of the initial acceleration phase (Phase I), final acceleration phase (Phase III), initial deceleration phase (Phase V) and the approaching phase or the final deceleration phase (Phase VII) forms a complete cycle of a standard sinusoidal wave. Although the trajectories of Phase III, Phase V and Phase VII are portions of a sine wave, each of these trajectories is delayed by a fixed angle.

2. Seek Trajectories Without Coast Mode

Let A denote the duration of initial acceleration phase, in which the rate of change of acceleration is positive. The duration of the acceleration should be no more than one-quarter of the total seek time. Therefore, there is a restraint on the parameter A:
A≦0.25 (1)

The combination of acceleration phase, transition phase and approaching phase forms a complete cycle of sine wave. The period of the sine wave is 4 A. There are phase delays associated with the transition phase and the approaching phase in the trajectory. The phase delays for the transition phase and the approaching phase are given below.

$${Θ}_{III} = π ( 1 - \frac{1}{4 A} ) , \\ {Θ}_{V} = 2 π ( 1 - \frac{1}{4 A} ) . \qquad ( 2 )$$

There are five phases in the seek trajectories associated with the generalized sinusoidal waveform. In these trajectories, the frequency and period of the sinusoidal wave are given, respectively, by

$$f = \frac{1}{4 A} , \\ T = \frac{1}{f} = 4 A . \qquad ( 3 )$$

For notation simplicity, we have used radian frequency ω and its reciprocal τ instead f and T to represent the frequency and period of the sinusoidal wave in these seek trajectories.

$$ω = 2 π f = \frac{π}{2 A} , \\ τ = \frac{1}{ω} = \frac{2 A}{π} . \qquad ( 4 )$$

Phase I: Initial Acceleration Phase (0≦x≦A)

The first phase of the seek trajectory is called the acceleration phase or the initial seek phase.
a_{I}(x)=sin ωx,
v_{I}(x)=τ(1−cos ωx),
d_{I}(x)=τ(x−τ sin ωx). (5)

Phase II: Constant Acceleration Phase (A<x≦½−A)

The second phase of the seek trajectory is the constant acceleration phase.

$${a}_{II} ( x ) = 1 , \\ {v}_{II} ( x ) = {v}_{1} + x - A , \\ {d}_{II} ( x ) = {d}_{1} - ( {v}_{1} - A ) A - \frac{{A}^{2}}{2} + ( {v}_{1} - A ) x + \frac{{x}^{2}}{2} . \qquad ( 6 )$$

Initial conditions for these trajectories are the end conditions of the previous phase. They are as follows.
v_{I}=v_{I}(A),
d_{I}=d_{I}(A). (7)
Phase III: Transition Phase (½−A<x≦½+A)

The third phase of the seek trajectory is the transition phase. The trajectory switches from acceleration phase to deceleration phase.

$${a}_{III} ( x ) = sin ( ω x + {Θ}_{III} ) , \\ {v}_{III} ( x ) = {v}_{2} - τ \{ cos ( ω x + {Θ}_{III} ) - cos [ ( \frac{1}{2} - A ) ω + {Θ}_{III} ] \} , \\ {d}_{III} ( x ) = {d}_{2} + \{ {v}_{2} + τ cos [ ( \frac{1}{2} - A ) ω + {Θ}_{III} ] \} ( x - \frac{1}{2} + A ) - {τ}^{2} \{ sin ( ω x + {Θ}_{III} ) - sin ( ( \frac{1}{2} - A ) ω + {Θ}_{III} ) \} . \qquad ( 8 )$$

Initial conditions for the above trajectories are

$${v}_{2} = {v}_{II} ( \frac{1}{2} - A ) , \\ {d}_{2} = {d}_{II} ( \frac{1}{2} - A ) . \qquad ( 9 )$$

Phase IV: Constant Deceleration Phase (½+A<x≦1−A)

The fourth phase of the seek trajectory is a constant deceleration phase.

$${a}_{IV} ( x ) = - 1 , \\ {v}_{IV} ( x ) = {v}_{3} - ( x - \frac{1}{2} - A ) , \\ {d}_{IV} ( x ) = {d}_{3} + ( {v}_{3} + \frac{1}{2} + A ) ( x - \frac{1}{2} - A ) - \frac{1}{2} [ {x}^{2} - {( \frac{1}{2} + A )}^{2} ] . \qquad ( 10 )$$

Initial conditions for these trajectories are

$${v}_{3} = {v}_{III} ( \frac{1}{2} + A ) , \\ {d}_{3} = {d}_{III} ( \frac{1}{2} + A ) . \qquad ( 11 )$$

Phase V: Approaching Phase (1−A<x≦1)

The final phase of the seek trajectory is the approaching phase or near end-of-seek phase.

$${a}_{V} ( x ) = sin ( ω x + {Θ}_{V} ) , \\ {v}_{V} ( x ) = {v}_{4} + τ \{ cos [ ( 1 - A ) ω + {Θ}_{V} ] - cos ( ω x + {Θ}_{V} ) \} , \\ {d}_{V} ( x ) = {d}_{4} + \{ {v}_{4} + τ cos [ ( 1 - A ) ω + {Θ}_{V} ] \} ( x - 1 + A ) + {τ}^{2} \{ sin [ ( 1 - A ) ω + {Θ}_{V} ] - sin ( ω x + {Θ}_{V} ) \} . \qquad ( 12 )$$

Initial conditions for the above trajectories are
v₄=v_{IV}(1−A),
d₄=d_{IV}(1−A). (13)

The duration of constant acceleration is equal to the duration of constant deceleration in the model for seek servomechanism presented herein. Let this duration be denoted by B. Then the duration B is related to A, the duration of the initial acceleration phase, by (FIG. 1)

$$( 2 A + B ) = \frac{1}{2} \qquad ( 14 )$$

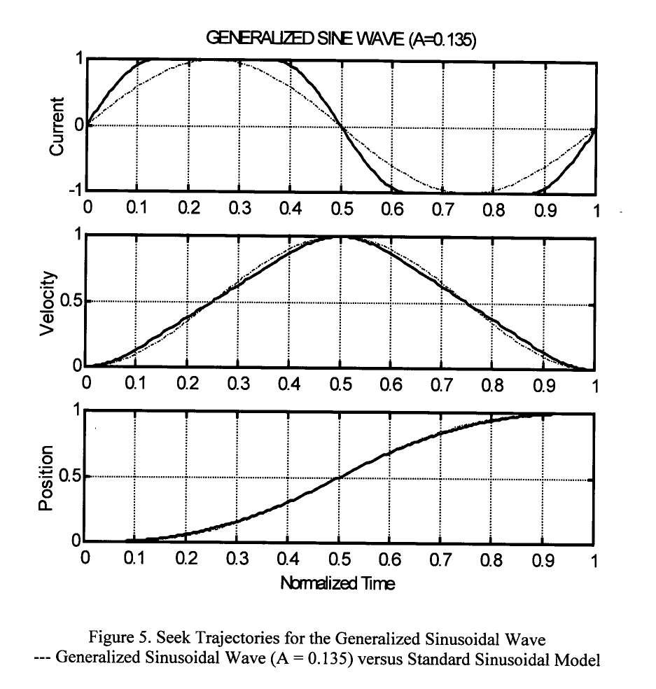

The comparison of seek trajectories with generalized sinusoidal current waveform (A=0.135 or C=0.23) with the corresponding trajectories of the sinusoidal seek method is shown in FIG. 5. The top trace in FIG. 5 shows the comparison of the acceleration trajectories between the generalized sinusoidal model and the standard sinusoidal wave. The middle trace shows the comparison of velocity trajectories. The comparison of the position trajectories is given at the bottom trace of FIG. 5.

3. Seek Trajectories on Phase Plane

The seek trajectories, including acceleration or current, velocity and position, have been expressed as functions of time. Since the time is a parameter in each design profile, these trajectories are said to be of the parametric form.

Depending on the design, there are two different controllers to apply the generalized sinusoidal wave to seek in the servomechanism of hard disk drive. The first type seek controller is the conventional approach, which relies on the availability of seek trajectories at any instant of servo interrupt. Since these seek trajectories are available at any time instant, they are the parametric trajectories.

The current input to voice coil motor (VCM) always follows a current trajectory, which is given in parametric form. However, the velocity trajectory and the position trajectory can be combined into a single trajectory on the phase plane by explicitly eliminating the time variable from these trajectories equations. The second type seek controller uses this seek trajectory on the phase plane. At any sampling instant of servo system, the head position is measured with a sensor or estimated using an observer (or estimator) when it is available in the servo system design. Given the head position, the design velocity at that particular position is extracted from the seek trajectory on the phase plane. The design velocity at that position is then compared against the actual velocity at that instant from either the estimator output or a tachometer output.

Using either seek controllers, the controller-output consists of three parts:
(1) The current corrections associate with the differences between the design velocity and measured velocity, and between the design position and measured position. These error terms are scaled by appropriate gains to yield current corrections.
(2) The design current, which is based on current trajectory at the instant of servo interrupt.
(3) The adjustment current to account for bias caused by flex cable and other sources

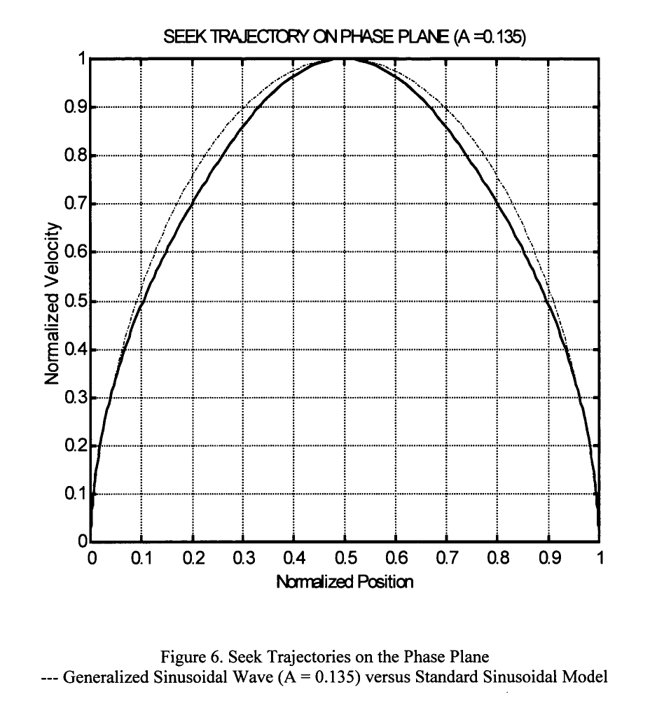

The parametric seek trajectories for velocity and position in FIG. 5 are combined into a single seek trajectory on the phase plane of FIG. 6. There are two seek trajectories on the same phase plane for the generalized sinusoidal waveform (continuous line) with A=0.135 (or C=0.23) and the standard sinusoidal waveform (dashed line) for comparison.

4. Trajectories With Coast Mode

In the above formulation for seek trajectories, there are only two modes in a seek trajectory: acceleration mode and deceleration mode. The acceleration mode consists of initial seek phase, constant acceleration phase and the first fifty percent of the transition phase. The deceleration mode consists of the second fifty percent of the transition phase, constant deceleration phase and the approaching phase.

For a typical long seek, there is one additional mode. In the design practice, we set a limit on the maximum speed of motion for recording head to assure reliably reading of Gray code. Once the design maximum speed is reached, the current has to reduce to zero and seek velocity retains at its design maximum. Such a mode is called coast mode.

Denote the duration of coast mode by C, and the duration of constant acceleration (or constant deceleration) by B, we have the following relationship for a complete cycle of a normalized generalized sinusoidal trajectory.
4A+2B+C=1. (15)

Define the symbols in the following for phase delays associated with a sinusoidal wave for Phase III, Phase V and Phase VII, respectively.

$${Θ}_{III} = π ( 1 - \frac{1 - C}{4 A} ) , \\ {Θ}_{V} = π ( 1 - \frac{1 + C}{4 A} ) , \\ {Θ}_{VII} = 2 π ( 1 - \frac{1}{4 A} ) . \qquad ( 16 )$$

The trajectories of acceleration, velocity and displacement (or position) for each of the seven phases in the generalized sinusoidal waveform are given separately in the following.

Phase I: Initial Acceleration Phase (0≦x≦A)
a_{I}(x)=sin ωx,
v_{I}(x)=τ(1−cos ωx),
d_{I}(x)=τ(x−τ sin ωx). (17)

Phase II: Constant Acceleration Phase (A<x≦½(1−C)−A
a_{II}(x)=1,
v_{II}(x)=(v_{I}−A)+x,
d_{II}(x)=d_{I}+(v_{I}−A)(x−A)+1/2(x−A)². (18)

Phase III: Final Acceleration Phase (½(1−C)<x≦½(1−C))

$${a}_{III} ( x ) = sin ( ω x + {Θ}_{III} ) , \\ {v}_{III} ( x ) = {v}_{2} + τ \{ cos [ ( \frac{1 - C}{2} - A ) ω + {Θ}_{III} ] - cos ( ω x + {Θ}_{III} ) \} , \\ {d}_{III} ( x ) = {d}_{2} + \{ {v}_{2} + τ cos [ ( \frac{1 - C}{2} - A ) ω + {Θ}_{III} ] \} [ x - \frac{1}{2} ( 1 - C ) + A ] - {τ}^{2} \{ sin ( ω x + {Θ}_{III} ) - sin [ ( \frac{1 - C}{2} - A ) ω + {Θ}_{III} ] \} , \qquad ( 19 )$$

Phase IV: Coast Mode Phase (½(1−C)<x≦½(1+C))

$${a}_{IV} ( x ) = 0 , \\ {v}_{IV} ( x ) = {v}_{3} = {V}_{Max} , \\ {d}_{IV} ( x ) = {d}_{3} + {v}_{3} [ x - \frac{1}{2} ( 1 - C ) ] . \qquad ( 20 )$$

Phase V: Initial Deceleration Phase ((½((1+C)<x≦½(1+C)+A)

$${a}_{V} ( x ) = sin ( ω x + {Θ}_{V} ) , \\ {v}_{V} ( x ) = {v}_{4} - τ [ - cos ( \frac{( 1 + C )}{2} ω + {Θ}_{V} ) + cos ( ω x + {Θ}_{V} ) ] , \\ {d}_{V} ( x ) = {d}_{4} + [ {v}_{4} + τ cos ( \frac{( 1 + C )}{2} ω + {Θ}_{V} ) ] [ x - \frac{1}{2} ( 1 + C ) ] - {τ}^{2} [ sin ( ω x + {Θ}_{V} ) - sin ( \frac{( 1 + C )}{2} ω + {Θ}_{V} ) ] . \qquad ( 21 )$$

Phase VI: Constant Deceleration Phase (½(1+C)+A<x≦1−A)

$${a}_{VI} ( x ) = - 1 , \\ {v}_{VI} ( x ) = {v}_{5} - [ x - \frac{1}{2} ( 1 + C ) - A ] , \\ {d}_{VI} ( x ) = {d}_{5} + [ {v}_{5} + \frac{1}{2} ( 1 + C ) + A ] [ x - \frac{1}{2} ( 1 + C ) - A ] - \frac{1}{2} [ {x}^{2} - \frac{{( 1 + C + 2 A )}^{2}}{4} ] . \qquad ( 22 )$$

Phase VII: Final Deceleration Phase (1−A<x≦1)

$${a}_{VII} ( x ) = sin ( ω x + {Θ}_{VII} ) , \\ {v}_{VII} ( x ) = {v}_{6} + τ \{ cos [ ( 1 - A ) ω + {Θ}_{VII} ] - cos ( ω x + {Θ}_{VII} ) \} , \\ {d}_{VII} ( x ) = {d}_{6} + \{ {v}_{6} - τ cos [ ( 1 - A ) ω + {Θ}_{VII} ] \} ( x - 1 + A ) - {τ}^{2} \{ sin ( ω x + {Θ}_{VII} ) - sin [ ( 1 - A ) ω + {Θ}_{VII} ] \} . \qquad ( 23 )$$

Initial velocities for the trajectories of Phase II through Phase VII are:

$${v}_{1} = {v}_{I} ( A ) , \\ {v}_{2} = {v}_{II} [ \frac{1}{2} ( 1 - C ) - A ] , \\ {v}_{3} = {v}_{III} [ \frac{1}{2} ( 1 - C ) ] , \\ {v}_{4} = {v}_{IV} [ \frac{1}{2} ( 1 + C ) ] = {V}_{Max} , \\ {v}_{5} = {v}_{V} [ \frac{1}{2} ( 1 + C ) + A ] , \\ {v}_{6} = {v}_{VI} ( 1 - A ) . \qquad ( 24 )$$

Initial displacements for the trajectories of Phase II through Phase VII are

$${d}_{1} = {d}_{I} ( A ) , \\ {d}_{2} = {d}_{II} [ \frac{1}{2} ( 1 - C ) - A ] , \\ {d}_{3} = {d}_{III} [ \frac{1}{2} ( 1 - C ) ] , \\ {d}_{4} = {d}_{IV} [ \frac{1}{2} ( 1 + C ) ] = {V}_{Max} , \\ {d}_{5} = {d}_{V} [ \frac{1}{2} ( 1 + c ) + A ] , \\ {d}_{6} = {d}_{VI} ( 1 - A ) . \qquad ( 25 )$$

The initial conditions for seek trajectories of a certain phase are the end conditions of its corresponding previous phase.

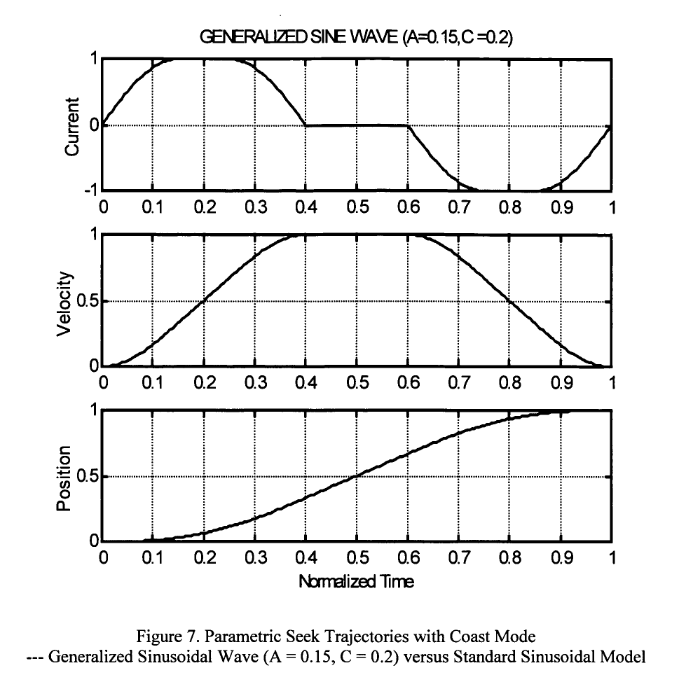

FIG. 7 shows the seek trajectories for the generalized sinusoidal current waveform with A=0.15 and C=0.2. The top trace is the trajectory showing normalized acceleration versus normalized time. Shown in the middle trace is the normalized velocity trajectory as a function of the normalized time. The bottom trace shows the normalized position trajectory versus the normalized time.

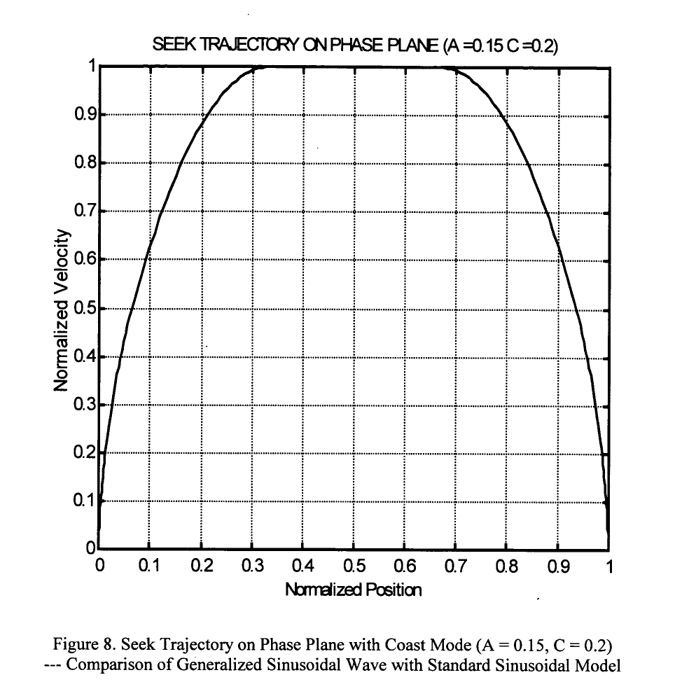

The velocity trajectory and the position trajectory in FIG. 7 are combined into a single seek trajectory on the phase plane by eliminated the variable of time from these two trajectories. The combined seek trajectory is shown on the phase plane in FIG. 8 with the coordinate as the velocity and the abscissa as the position.

5. Seek Length Versus Seek Time

For any general current profile, the relationship between seek length (X_{SK}) and seek time (T_{SK}) is given by the following equation.

$${T}_{SK} = ψ \sqrt{\frac{1}{{K}_{VCM} {I}_{MAX}} {X}_{SK}} = ψ \sqrt{\frac{J}{{K}_{T} {I}_{MAX}} {X}_{SK}} . \qquad ( 26 )$$

In the abode equation, we have used the following notations.

K_{VCM}=K_{T}/J=VCM constant,

K_{T}=VCM torque constant,

J=Mass moment of the inertia,

I_{MAX}=Maximum current

The constant ψ in Eq. (26) is determined by the following equation.

$$ψ = \frac{1}{\sqrt{{d}_{V} ( 1 )}} . \qquad ( 27 )$$

In Eq. (27), d_{V}(1), computed using the position trajectory of Phase V given in Eq. (12), stands for the dimensionless seek length at the end of seek.

For a more general seek trajectory such as a generalized sine seek profile, the parameter ψ falls in between the two limits.
2<ψ<\sqrt{2π}. (28)

TABLE 1
Parameter ψ As A Function of A* for Generalized Sine Model

| A | B | ψ | Remark |
|---|---|---|---|
| 0.010 | 0.48 | 2.0149 | Getting closer to bang-bang control |
| 0.050 | 0.40 | 2.0780 | |
| 0.100 | 0.30 | 2.1658 | |
| 0.135 | 0.23 | 2.2335 | |
| 0.150 | 0.20 | 2.2645 | |
| 0.200 | 0.10 | 2.3809 | |
| 0.250 | 0.00 | 2.5155 | Pure sine wave |

$\begin{matrix}\text{*Note:} \\ B = \frac{1}{2} - 2 A ( FIG . 1 or Eq . 14 )\end{matrix}$

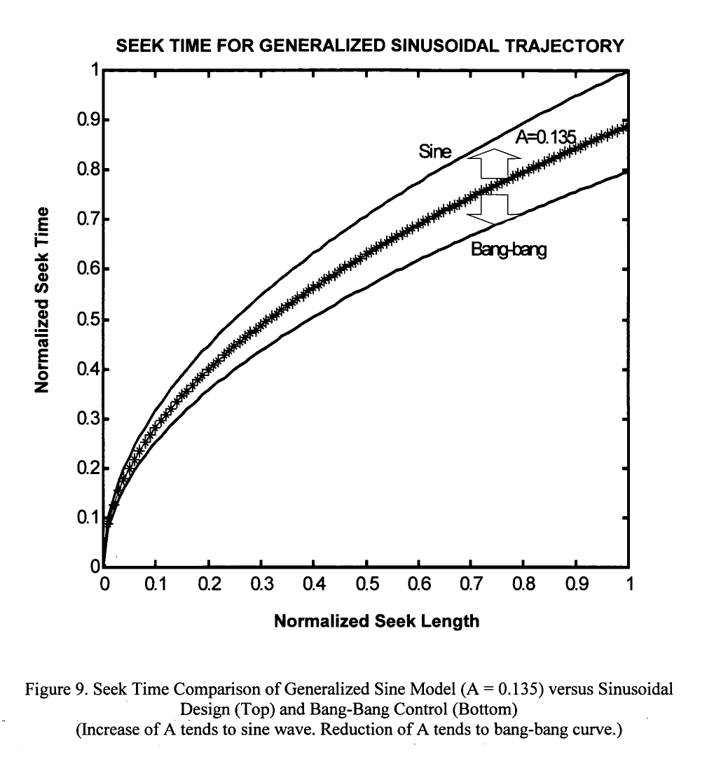

It is easy to make movement time comparison of different waveforms for relatively short seeks without coast mode. FIG. 9 shows the seek time comparison for servo seek mechanism with bang-bang control, sinusoidal seek method and generalized sinusoidal seek waveform with A=0.135 as current profile, respectively. It is noted that the bang-bang control algorithm has the shortest seek time, and the sinusoidal seek is the slowest among the three. The seek time for the generalized sinusoidal seek model falls in between these two extremes. However, the seek time for the generalized sinusoidal seek model is adjustable. As the parameter B of the generalized sinusoidal waveform increases, the waveform gets closer to the bang-bang current trajectory, and its corresponding seek time becomes shorter.

6. Controller Design

There are two different seek controllers available:
(1) Seek controller using seek trajectories of parametric form.
(2) Seek controller on the phase plane.

Denote Xₑᵣᵣ(n) and Vₑᵣᵣ(n) as position error and velocity error, which are the differences between design position and actual position, and design velocity and actual velocity at the time instant n, respectively.

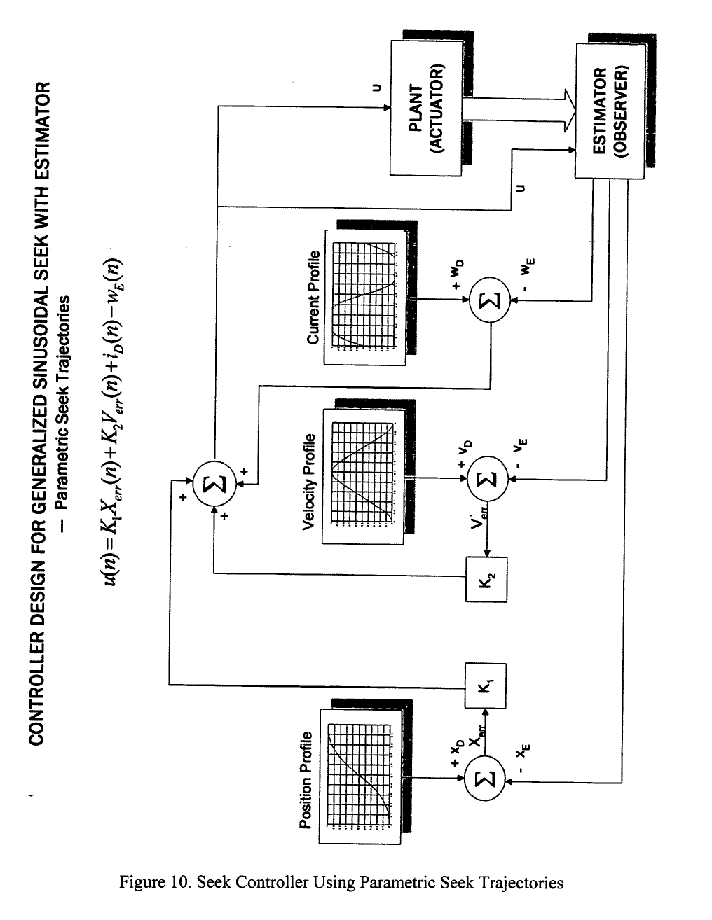

The control current for the parametric form seek controller (FIG. 10) is given by
u(n)=K₁Xₑᵣᵣ(n)+K₂Vₑᵣᵣ(n)+i_{D}(n)−w_{E}(n) (29)

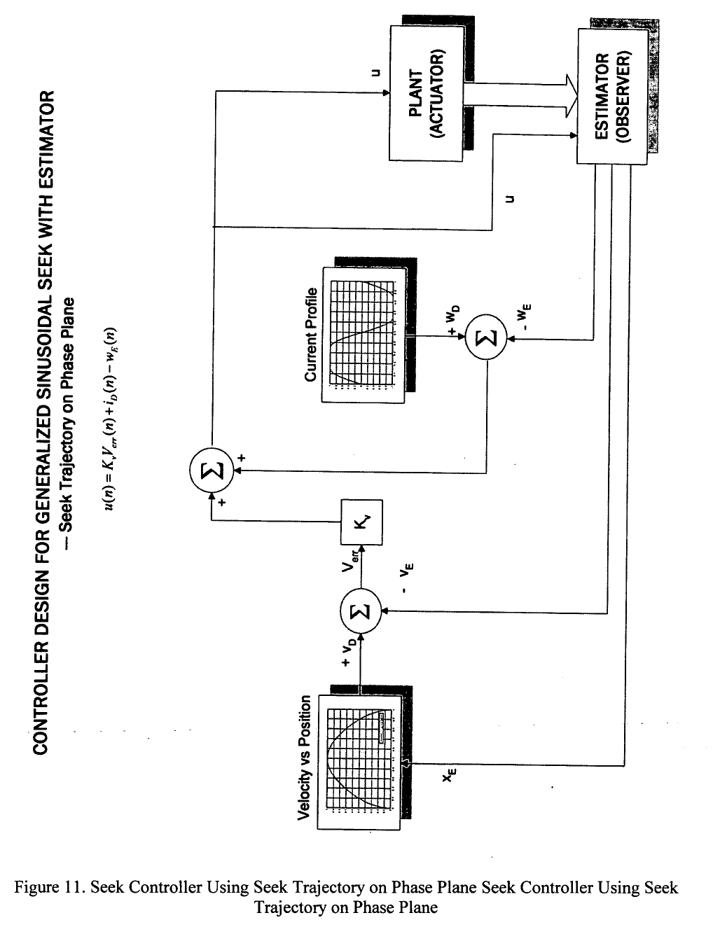

For seek controller on the phase plane (FIG. 11), the controller current is computed as follows.
u(n)=K_{V}Vₑᵣᵣ(n)+i_{D}(n)−w_{E}(n) (30)

Note that the parametric trajectories are explicitly dependent on time. The seek trajectory on the phase plane is explicitly dependent on position; however, it is implicitly dependent on time.

What is claimed is:

1. A hard disk drive, comprising:
(a) a disk which has a surface;
(b) a spindle motor that spins said disk at a constant rotational speed;
(c) a transducer which can write information onto said disk and read information from said disk;
(d) an actuator arm that can move said transducer across said surface of said disk; and,
(e) a controller that controls said actuator arm so that said transducer moves across said disk surface with an essentially generalized sinusoidal acceleration trajectory.

2. The disk drive of claim 1, wherein said controller is a digital signal processor.

3. The hard disk drive of claim 2, wherein said digital signal processor controls said actuator arm in accordance with a seek controller algorithm.

4. The hard disk drive of claim 1, wherein said controller performs a servo routine that outputs current to vary the movement of said transducer.

5. The hard disk drive of claim 4, wherein said current is a function of design trajectories and actual position, velocity and bias of the transducer.

6. The hard drive of claim 5, wherein said design trajectories are acceleration, velocity and position trajectories derived from generalized sinusoidal current profile applied to excite said actuator arm.

7. A method for moving a transducer across a surface of a disk with a controller, comprising the steps of:
(a) exciting an actuator arm that is coupled to the transducer so that the transducer moves across the disk surface with a generalized sinusoidal acceleration trajectory.
(b) computing a design position for the transducer;
(c) determining an actual position of the transducer;
(d) generating a position correction current that is proportional to the discrepancy of the design position and the actual position;
(e) computing a design velocity for the transducer;
(f) determining an actual velocity of the transducer;
(g) generating a velocity correction current that is proportional to the discrepancy of the design velocity and the actual velocity;
(h) computing a design current for the transducer;
(i) determining bias current for the transducer;
(j) generating an exciting current to excite the actuator arm that is the sum of position correction current, velocity correction current and the design current subtracted by bias current;
(k) varying the movement of the transducer in response to said exciting current.

8. The method of claim 7, wherein said controller uses separate position and velocity trajectories that are functions of time.

9. The method of claim 7, wherein said design position is computed in correspondence to said generalized sinusoidal acceleration trajectory.

10. The method of claim 7, wherein said design velocity is computed in correspondence to said generalized acceleration trajectory.

11. The method of claim 7, wherein said design current is computed in correspondence to said generalized acceleration trajectory with the multiplication of a design related constant.

12. The method of claim 7, where said design current is normalized so that a single trajectory is representative for any seek lengths.

13. The method of claim 7, wherein said design position and said design velocity are normalized so that they are independent of seek length.

14. A method for moving a transducer across a surface of a disk with a seek controller, comprising the steps of:
(a) exciting an actuator arm that is coupled to the transducer so that the transducer moves across the disk surface with a generalized sinusoidal acceleration trajectory;
(b) computing a design position for the transducer;
(c) determining an actual position of the transducer;
(d) computing a design velocity for the transducer;
(e) generating seek trajectory on the phase plane using the design position as abscissa and the design velocity as the coordinate;
(f) determining an actual velocity of the transducer;
(g) extracting a design velocity of the transducer for the actual position from the seek trajectory;
(h) generating a velocity correction current that is proportional to the discrepancy of design velocity and the actual velocity;
(i) computing a design current for the transducer;
(j) determining bias current for the transducer;
(k) generating current to excite the actuator arm that is the sum of velocity correction current and the design current subtracted by bias current; and,
(l) varying the movement of the transducer in response to the generation of the current output.

15. The method of claim 12, wherein said controller uses a combined position and velocity seek trajectory on the phase plane.

16. The method of claim 12, wherein said design position is computed in accordance with said generalized acceleration trajectory.

17. The method of claim 12, wherein said design velocity is computed in accordance with said generalized acceleration trajectory.

18. The method of claim 12, wherein said design current is generated in correspondence to said generalized acceleration trajectory with the multiplication of a design related constant.

19. The method of claim 12, where said design current is normalized so that a single trajectory is representative for any seek lengths.

20. The method of claim 12, wherein said design position and said design velocity comprising the seek trajectory on phase plane are normalized so that the said seek trajectory is independent of seek length.
